(19) United States
(12) Patent Application Publication
(10) Pub. No.: US 2022/0177263 A1
(43) Pub. Date: Jun. 9, 2022

(54) METHOD OF PREVENTING GRAVITY JUMP AT EMERGENCY STOP IN ELEVATOR SYSTEMS

(71) Applicant: Otis Elevator Company, Farmington, CT (US)

(72) Inventor: Uwe Schönauer, Berlin (DE)

(21) Appl. No.: 17/396,096

(22) Filed: Aug. 6, 2021

(30) Foreign Application Priority Data
Dec. 4, 2020 (EP) 20212046.5

(51) Int. Cl. B66B 1/32; B66B 5/02; B66B 1/34

(52) U.S. Cl. CPC B66B 1/32; B66B 1/3492; B66B 5/02

(57) ABSTRACT

A method of controlling an elevator car (22) includes driving the elevator car (22) with a drive system (30) including a drive device (32) and a brake device (36); detecting an emergency stop condition; triggering the brake device (36) in response to detecting an emergency stop condition; determining a delay to be applied between triggering the brake device (36) and stopping the drive device (32); and waiting for a time period corresponding to the delay before stopping the drive device (32).

### FOREIGN PRIORITY

This application claims priority to European Patent Application No. 20212046.5, filed Dec. 4, 2020, and all the benefits accruing therefrom under 35 U.S.C. § 119, the contents of which in its entirety are herein incorporated by reference.

### TECHNICAL FIELD

The present disclosure relates to elevator systems and methods of controlling an elevator car, in particular upon detecting an emergency stop condition.

### BACKGROUND

Typical elevator systems comprise one or more elevator cars running in a hoistway to transport passengers or cargo between floors of a building. A drive system is controlled to drive the elevator car between the floors (e.g. using a drive device connected to a drive sheave that engages a tension member from which the elevator car is suspended). The drive system typically also includes one or more brake devices for decelerating the elevator car (e.g. by applying braking force to the drive sheave).

Safety is very important in elevator systems, and so elevator systems normally feature a safety chain made up of several electronic relays connected in series and controlled by respective sensors such as hoistway door sensors or overspeed sensors. The safety chain controls the supply of power to the drive system. If any unsafe condition (such as an open hoistway door) is detected by one of the sensors, the corresponding relay opens, breaking the safety chain and triggering an emergency stop of the elevator car by cutting power to the drive system. Driving force is removed and the brakes are applied, quickly slowing the car to a halt.

In prior art systems, an emergency stop condition automatically interrupts the power supply to the whole drive system including the drive and brake devices. However, brake devices in elevator systems cannot produce braking force instantly, e.g. due to the time it takes a brake shoe to physically move into full engagement. This is known as a “brake-drop delay”. In contrast, the removal of driving force once the power supply to a drive device is interrupted can be very quick. Thus, in a short period after an emergency stop is triggered, no drive force and little or no braking force may be applied to the elevator car. This can result in a “gravity jump”, in which the elevator car is actually free to accelerate for a short period of time immediately after an emergency stop is triggered. Whilst this short period of acceleration is not typically unsafe, it means that when the brakes eventually do engage they may have to do so more aggressively and for longer (because the car is travelling more quickly), which can be disconcerting and inconvenient to passengers. The initial acceleration can also be disconcerting. Furthermore, if an emergency stop is triggered just as an elevator car is slowing to arrive at a floor, the jump can cause the car to unexpectedly overshoot a floor stopping position by a short distance, which is inconvenient to passengers, can cause elevator controller errors and can also be contrary to regulatory code requirements. An alternative approach may be desired.

### SUMMARY

According to a first aspect of the present disclosure there is provided a method of controlling an elevator car, the method comprising: driving the elevator car with a drive system including a drive device and a brake device; detecting an emergency stop condition; triggering the brake device in response to detecting an emergency stop condition;

determining a delay to be applied between triggering the brake device and stopping the drive device; and waiting for a time period corresponding to the delay before stopping the drive device.

According to a second aspect of the present disclosure there is provided an elevator system comprising: an elevator car; a drive system comprising a drive device and a brake device, the drive system arranged to drive the elevator car; and a safety system configured to: detect an emergency stop condition; trigger the brake device in response to detecting an emergency stop condition; determine a delay to be applied between triggering the brake device and stopping the drive device; and wait for a time period corresponding to the delay before stopping the drive device.

Thus, by waiting for a time period corresponding to the delay before stopping the drive device, the drive device continues to drive the elevator car for at least some of the time between triggering the brake device and substantive braking force actually being generated (i.e. during a brake drop delay experienced by the brake device).

As a result, gravity jumps are at least partially mitigated, improving ride comfort and convenience and reducing the likelihood of controller errors.

Furthermore, because the drive device is stopped after the determined time period, rather than continuing to operate indefinitely, it is less likely to oppose braking force eventually generated by the brake device for a significant amount of time. This reduces the likelihood of excessive brake wear or even failures of the brake device and/or the drive device. In addition, because the drive device continues to drive the elevator car after triggering the brake device, the acceleration of the elevator car during the delay may be lower compared to the acceleration experienced during a gravity jump, meaning that the elevator car does not travel as far before the brakes are engaged and the emergency stop may therefore be carried out over a shorter distance. This may allow for higher operating speeds and/or tighter operational margins such as higher deceleration profiles to a terminal floor or the use of terminal buffers with lower maximum impact velocities.

In prior art systems, an emergency stop condition automatically opens an electric safety chain that interrupts the power supply to the whole drive system (i.e. including drive and brake devices), preventing any independent control over the drive and brake devices. In contrast, in examples of the present disclosure the drive and brake devices may operate independently. In some examples, the safety system comprises a safety controller (e.g. a PESSRAL node such as a node defined as a Programmable Electronic System in Safety Related Applications for Lifts according to the relevant standard(s)), to facilitate independent safety control over the drive and brake devices. In some examples, the safety controller may be arranged to trigger the brake device independently of stopping the drive device. In some examples, in addition or alternatively, the safety controller may be configured to determine the delay to be applied between triggering the brake device and stopping the drive device; and to wait for the time period corresponding to the delay before stopping the drive device.

In some examples of the present disclosure, the safety system comprises a safety chain configured to detect an emergency stop condition. The step of detecting an emergency stop condition may comprise opening a safety chain. Thus, the triggering of the brake device may correspond to opening of the safety chain. For example, the safety chain may include a power supply or power supply switch for the brake device. This means that the brake device can be triggered directly in response to the safety chain detecting an emergency stop condition, while the safety controller can calculate the delay to be applied before stopping the drive device. In some examples the safety chain may be connected to the safety controller, to assist with determining the delay to be applied.

An emergency stop condition may comprise any indication that the elevator car should be brought quickly to a halt. Emergency stop conditions include those related to a motion hazard, such as a hoistway door being open, an elevator car door being open, an elevator car over-speed or over-acceleration, a terminal landing issue (e.g. where the elevator car is travelling too quickly to stop at a terminal landing), or the engagement and/or disengagement by a mechanic of inspection modes (e.g. via manual switches in the pit of the hoistway or on top of the car).

Emergency stop conditions also include electrical hazards, such as overvoltage or overcurrent conditions, short circuit detection and electrical circuit or sensor failures.

In some examples of the present disclosure, the stopping of the drive device may only be delayed for motion-hazard emergency stop conditions, i.e. with no delay to the stopping of the drive device in case of an electrical-hazard emergency stop condition. This allows gravity jumps to be mitigated in a large number of emergency stop situations (the majority of emergency stops are typically caused by motion-hazards), whilst ensuring safety in emergency stop conditions where precise electrical control of the elevator system (e.g. to delay the stopping of the drive device) may not be relied upon. Thus, in some examples, the method may comprise determining whether the emergency stop condition is a motion-hazard emergency stop condition, and only waiting for the time period corresponding to the delay before stopping the drive device if the emergency stop condition is a motion-hazard emergency stop condition.

In some examples of the present disclosure, stopping the drive device comprises interrupting an electrical power supply to the drive device. This interruption may be effected by the safety system (e.g. by the safety controller) after waiting for a time period corresponding to the delay, as described above. The drive device may comprise an electric motor, for instance supplied with power from a mains supply via a rectifier and an inverter. In some such examples, stopping the drive device may comprise interrupting the supply of power to the electric motor (e.g. by interrupting the supply of power to an inverter).

In some examples of the present disclosure, triggering the brake device comprises interrupting an electrical power supply to the brake device (e.g. by opening a power supply relay). This interruption may be effected by a safety chain detecting an emergency stop condition, as described above. Alternatively, this interruption may be effected by a safety controller (e.g. connected to a safety chain). The brake device may comprise an electromechanical brake, in which one or more brake shoes are biased (e.g. with a spring) towards a braking surface (e.g. a brake disc coupled to a drive sheave), but held out of engagement by an electromagnet (e.g. a solenoid). In such devices, when power to the electromagnet is interrupted, the brake shoe is urged to engage the braking surface, generating braking force. In such examples, triggering the brake device may comprise interrupting a supply of power to the electromagnet.

The delay to be applied between triggering the brake device and stopping the drive device may be predetermined (i.e. decided before the brake device is triggered). In such examples, the delay may be determined, for instance, by retrieving a pre-set delay from a memory (e.g. a hard-coded delay value). A predetermined delay may correspond to an expected brake drop delay of the brake device, i.e. the length of time the brake device is expected to take to achieve a desired level of braking force (e.g. 70%, 80% or 90% of a nominal maximum braking force).

The delay may simply be chosen to be equal to an expected brake drop delay of the brake device, although in some examples the delay may be chosen to be longer than an expected brake-drop delay (e.g. to increase the chance of a gravity jump being entirely avoided), or shorter than an expected brake-drop delay (e.g. to decrease the chance that the drive device continues to drive after the brake device has fully engaged, risking damage).

An expected brake drop delay may comprise a nominal brake drop delay specified for the type or model of elevator system or brake device in use, or even for the particular brake device that is in use (e.g. determined in factory testing). Additionally or alternatively, the delay may be determined based on previous operational performance of the brake device, e.g. comprising a mean or median value of some or all of the brake drop delays experienced previously by the brake device.

In some examples, additionally or alternatively, the delay may be determined by measuring, directly or indirectly, a level of braking force that is being applied by the brake device. The length of the delay may comprise the time taken for the measured level of braking force to reach a predetermined level (e.g. 70%, 80% or 90% of a nominal maximum braking force). Measuring a level of braking force that is actually being applied by the brake device may comprise monitoring motion of the elevator car (e.g. a magnitude of deceleration) after the brake device has been triggered. The stopping of the drive device may be delayed until the motion of the elevator car indicates that a desired level of braking force is being applied (i.e. when the brake device is sufficiently engaged). The motion of the elevator car may be monitored with an absolute position measurement system arranged to determine elevator car position and/or velocity (e.g. at a high frequency), although alternative monitoring approaches such as using a rotary encoder or visual monitoring are possible. The absolute position measurement system may be connected to the safety system or included as part of the safety system.

As mentioned above, the acceleration of the elevator car during the delay time period is likely to be lower than the acceleration experienced in a conventional system wherein the drive device is stopped at the same time as the brake device, because even if the drive motion profile in progress when the emergency stop condition arises is simply continued through the brake-drop delay this is unlikely to involve the magnitude of elevator car acceleration experienced when the drive device is stopped and the brake device is not providing braking force. Whilst some phases of drive motion profiles can involve large accelerations (e.g. as the car departs a floor), there are many other phases which feature smaller or zero accelerations, or decelerations.

However, many drive devices are capable of decelerating the car (albeit usually at a lower rate than the brake device), and in some examples the drive device may be controlled to decelerate the elevator car (e.g. at a maximum possible deceleration rate) after the brake device is triggered (e.g. simultaneously with triggering the brake device). For example, the drive device may comprise a regenerative drive device arranged to convert motion of the car back into electrical power, decelerating the car in the process (regenerative braking), without the need for mechanical brakes. Once the time period corresponding to the delay has elapsed, this regenerative braking is stopped.

The elevator system may comprise an elevator controller arranged to control the drive system, e.g. to control the elevator car to respond to elevator calls. The elevator controller and the safety controller may be provided as part of a single controller device.

Features of any aspect or example described herein may, wherever appropriate, be applied to any other aspect or example described herein. Where reference is made to different examples, it should be understood that these are not necessarily distinct but may overlap.

### DRAWING DESCRIPTION

One or more non-limiting examples will now be described, by way of example only, and with reference to the accompanying figures in which:

FIG. 1 is a schematic view of an elevator system;

FIG. 2 is a velocity-distance diagram illustrating the trajectory of a conventional emergency stop; and

FIG. 3 is a velocity-distance diagram illustrating the trajectory of an emergency stop carried out according to an example of the present disclosure.

### DETAILED DESCRIPTION

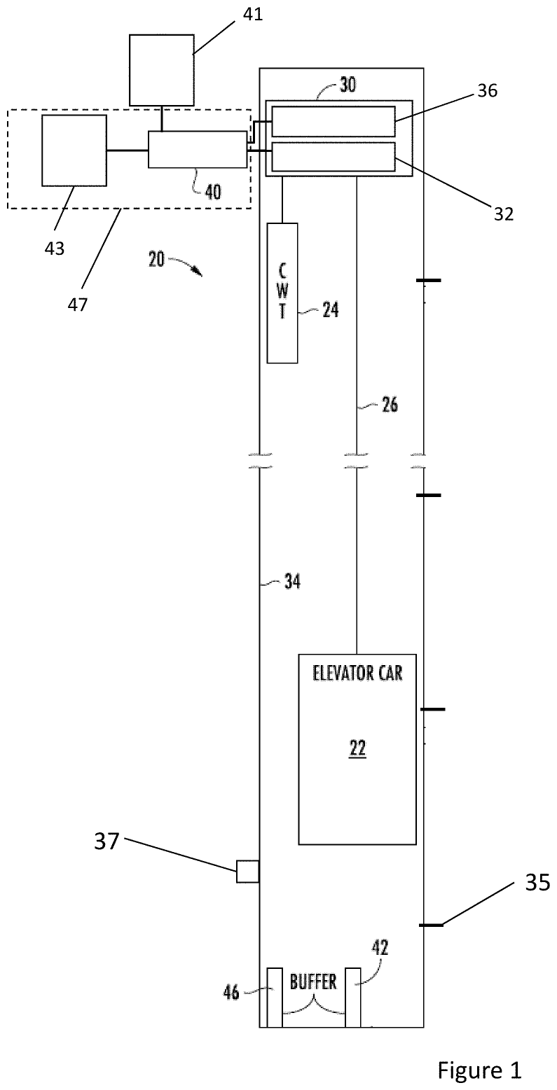

As shown in FIG. 1, an elevator system 20 comprises an elevator car 22 that runs in a hoistway 34 between various floors of a building. The elevator car 22 is suspended in the hoistway 34 by a tension member 26 (e.g. comprising one or more ropes or belts). The other end of the tension member 26 is connected to a counterweight 24. The elevator car 22 and the counterweight 24 are moving components in the elevator system 20. However, it will be appreciated that in other examples the elevator system may be ropeless.

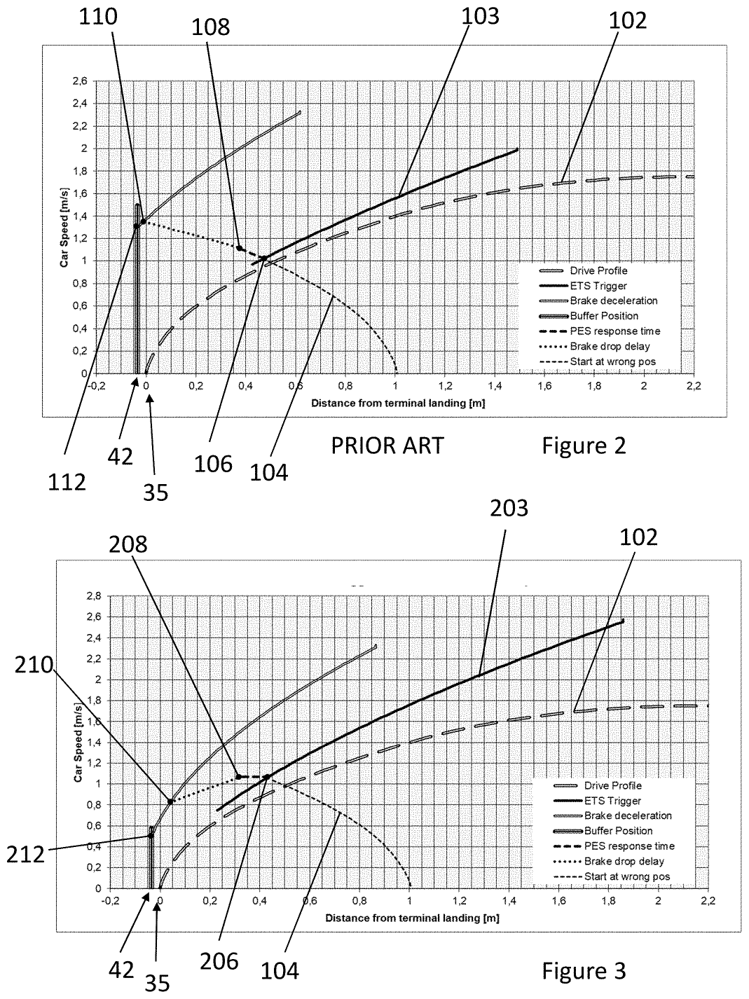

The bottom of the hoistway 34 includes a first buffer 42 located underneath the elevator car 22 and a second buffer 46 located underneath the counterweight 24. The buffers 42, 46 are located just below a terminal landing 35 of the elevator system 20 (i.e. stopping point for the lowermost floor in the building) and are arranged to act as shock absorbers to bring the elevator car 22 and/or counterweight 24 quickly but gently to a halt if it should overrun the terminal landing 35. An emergency terminal stopping device (ETSD) 37 is arranged to detect if the elevator car 22 or the counterweight 24 is travelling too quickly on approach to the terminal landing 35, and to trigger an emergency stop if so. The ETSD 37 may, for instance, comprise a series of sensors located at points in the hoistway near to the terminal landing 35. If the elevator car 22 passes one of the sensors travelling above a pre-set speed threshold, an emergency stop is triggered. A permissible motion profile (“ETS trigger”) 103 that falls just within these speed thresholds is shown in FIG. 2.

During normal operation, the elevator car 22 travels up and down in the hoistway to transport passengers and/or cargo between floors of the building. The elevator car 22 is driven by a drive system 30 comprising a drive device 32 and a brake device 36. The tension member 26 passes over a drive sheave (not shown) that is driven to rotate by the drive device 32 and braked by the brake device 36.

In an emergency stop situation, the drive device 32 and the brake device 36 are controlled by a safety controller 40. Normal operation of the drive system 30 may be controlled by a separate elevator controller (not shown). The safety controller 40 may be connected to an absolute position measurement system 41. The safety controller 40 may comprise a PESSRAL node. The elevator system 20 also comprises a safety chain 43 configured to detect emergency stop conditions. The safety chain 43 is connected to the safety controller 40 (which may be considered part of the safety chain) and together they form a safety system 47.

The conventional approach to emergency stops is illustrated in FIG. 2, which shows a normal trajectory (“drive profile”) 102 of the elevator car 22 approaching the terminal landing 35, and an improper trajectory (“start at wrong pos”) 104 of the elevator car 22 approaching the terminal landing 35 too quickly, such that a conventional emergency stop is triggered.

The normal trajectory 102 shows the elevator 22 gradually slowing to a halt at the position of the terminal landing 35. However, the improper trajectory 104 shows the elevator car 22 accelerating towards the terminal landing 35, such that at a point 106 approximately 0.45 m above the terminal landing 35, the elevator car 22 is travelling at approximately 1 ms⁻¹. After a short electronic reaction time (“PES response time”), in which the elevator car 22 continues to travel and accelerate to point 108, this causes the emergency terminal stopping device 37 to trigger an emergency stop of the elevator car 22 by opening the safety chain 43 and interrupting the supply of power to the whole drive system 30 (i.e. cutting power to the drive device 32 and the brake device 36).

The drive device 32 immediately stops driving the drive sheave, and the brake device 36 is triggered to engage. However, due to the inherent brake-drop delay of the brake device 36, for a short period of time immediately after the emergency stop is triggered, little or no braking force is actually generated by the brake device 36. Because the power supply to the drive device 32 has also been interrupted, there is also no driving force applied to the elevator car 22. Thus, the elevator car 22 continues to travel and accelerate to point 110 on a brake deceleration profile, roughly level with the terminal landing 35 (i.e. still slightly above the buffer position 42) and travelling at approximately 1.4 ms⁻¹. Only after this brake drop delay does the brake device 36 start to generate a substantial level of braking force and the elevator car 22 begins to decelerate, slowing slightly before impacting the buffer 42 at point 112 at a speed of approximately 1.3 ms⁻¹.

FIG. 3 illustrates a method of controlling the elevator car 22 according to an example of the present disclosure. FIG. 3 again shows the normal trajectory (“drive profile”) 102 of the elevator car 22 approaching the terminal landing 35, and an improper trajectory (“start at wrong pos”) 104 of the elevator car 22 approaching the terminal landing 35 too quickly, such that an emergency stop is triggered when the improper trajectory 104 intersects a permissible motion profile (“ETS trigger”) 203. It will be appreciated that the permissible motion profile 203 represents the maximum permitted speed at any given point in the hoistway, above which an emergency stop will be triggered. The safety controller 40 may use information from the absolute position measurement system 41 to compare the speed of the elevator car 22 to the permissible motion profile 203, as well as or instead of relying on the ETSD 37. An emergency stop is triggered by opening the safety chain 43.

The normal trajectory 102 again comprises a gradual deceleration before stopping at the terminal landing 35. However, the improper trajectory 104 shows the elevator car 22 accelerating towards the terminal landing 35, such that at a point 206 approximately 0.4 m above the terminal landing 35, the elevator car 22 is travelling at approximately 1.1 ms⁻¹, which is above the permitted threshold speed for that position. Therefore, after a short electronic reaction time (“PES response time”) (e.g. a reaction time of the emergency terminal stopping device 37 and/or the safety chain 43) in which the elevator car 22 continues to travel and accelerate to point 208, the emergency terminal stopping device 37 triggers an emergency stop of the elevator car 22 by opening the safety chain 43. This triggers the safety controller 40 to immediately interrupt the supply of power to the brake device 36, triggering the brake device 36. However, the drive device 32 continues to be powered and to drive the elevator car 22 via the drive sheave.

The safety controller 40 then determines a delay to be applied between triggering the brake device 36 (at point 208) and stopping the drive device 32, for instance by retrieving from memory an expected brake-drop delay for the brake device 36. The safety controller 40 then waits for a for a time period corresponding to the delay before stopping the drive device 32 at point 210 (e.g. by interrupting a power supply to an inverter of the drive device 32). During the delay time period, the safety controller 40 controls the drive device 32 to decelerate the elevator car 22, such that at the end of the delay time period at point 210, the elevator car 22 is located just above the terminal landing 35 and travelling at approximately 0.8 ms⁻¹.

Because the delay time period corresponds to the expected brake drop delay for the brake device 36, at this point 210 the brake device 36 starts to generate a substantial level of braking force and the deceleration of the elevator car 22 increases, slowing the elevator car 22 to approximately 0.5 ms⁻¹ before impacting the buffer 42 at point 212.

Thus, by delaying the stopping of the drive device 32 after the brake device 36 is triggered, not only is a gravity jump avoided but the eventual impact velocity with the buffer 42 is also reduced even when the emergency stop is triggered closer to the terminal landing 35. This means the ETSD emergency stop threshold speeds can be increased and/or the threshold positions moved closer to the terminal landing 35, allowing more efficient elevator motion profiles to be used (e.g. with higher operating speeds and/or higher deceleration profiles). For instance, in the example shown in FIG. 3, the example permissible motion profile (“ETS trigger”) 203 involves generally higher speeds at the same positions than the comparable motion profile 103 in FIG. 2.

While the disclosure has been described in detail in connection with only a limited number of examples, it should be readily understood that the disclosure is not limited to such disclosed examples. Rather, the disclosure can be modified to incorporate any number of variations, alterations, substitutions or equivalent arrangements not heretofore described, but which are commensurate with the scope of the disclosure. Additionally, while various examples of the disclosure have been described, it is to be understood that aspects of the disclosure may include only some of the described examples. Accordingly, the disclosure is not to be seen as limited by the foregoing description, but is only limited by the scope of the appended claims.

What is claimed is:

1. A method of controlling an elevator car (22), the method comprising:
driving the elevator car (22) with a drive system (30) including a drive device
(32) and a brake device (36);
detecting an emergency stop condition;
triggering the brake device (36) in response to detecting an emergency stop condition; determining a delay to be applied between triggering the brake device (36) and stopping the drive device (32); and
waiting for a time period corresponding to the delay before stopping the drive device (32).

2. A method as claimed in claim 1, comprising determining whether the
detected emergency stop condition is a motion-hazard emergency stop condition, and only waiting for the time period corresponding to the delay before stopping the drive device (32) if the emergency stop condition is a motion-hazard emergency stop condition.

3. A method as claimed in claim 1, wherein the delay to be applied between triggering the brake device (36) and stopping the drive device (32) is predetermined.

4. A method as claimed in claim 3, wherein the predetermined delay to be applied between triggering the brake device (36) and stopping the drive device (32) corresponds to an expected brake drop delay of the brake device (36).

5. A method as claimed in claim 1, comprising determining the delay to be applied by measuring a level of braking force that is applied in use by the brake device (36).

6. A method as claimed in claim 5, wherein measuring a level of braking force that is applied in use by the brake device (36) comprises monitoring motion of the elevator car (22) after the brake device (36) has been triggered.

7. A method as claimed in claim 1, comprising controlling the drive device (32) to decelerate the elevator car (22) after the brake device (36) is triggered.

8. A method as claimed in claim 1, wherein detecting an emergency stop condition comprises opening a safety chain.

9. An elevator system (20) comprising: an elevator car (22); and
a drive system comprising a drive device (32) and a brake device, the drive system (32) arranged to drive the elevator car (22); and
a safety system (47) configured to: detect an emergency stop condition;
trigger the brake device (36) in response to detecting an emergency stop condition;
determine a delay to be applied between triggering the brake device (36) and stopping the drive device (32); and
wait for a time period corresponding to the delay before stopping the drive device (32).

10. An elevator system (20) as claimed in claim 9, wherein the safety system
(47) comprises a safety controller (40) configured to:
determine the delay to be applied between triggering the brake device (36) and stopping the drive device (32); and
wait for the time period corresponding to the delay before stopping the drive device (32).

11. An elevator system (20) as claimed in claim 9, wherein the safety system (47) comprises a safety chain (43) configured to detect an emergency stop condition.

12. An elevator system (20) as claimed in claim 9, comprising an absolute position measurement system (41) arranged to determine elevator car (22) position and/or velocity.

13. An elevator system (20) as claimed in claim 12, wherein the safety system
(47) is arranged to determine the delay to be applied by monitoring motion of the elevator car (22), after the brake device (36) has been triggered, using the absolute position measurement system (41).
